(19) United States
(12) Patent Application Publication
(10) Pub. No.: US 2016/0018754 A1
(43) Pub. Date: Jan. 21, 2016

(54) LIGHT EMISSION ELEMENT ARRAY CHIP, CHIP MOUNTING SUBSTRATE, AND IMAGE FORMING APPARATUS

(71) Applicants: Takashi Michiyoshi, Osaka (JP); Tetsuroh Tatebe, Osaka (JP)

(72) Inventors: Takashi Michiyoshi, Osaka (JP); Tetsuroh Tatebe, Osaka (JP)

(73) Assignee: RICOH COMPANY, LTD., Tokyo (JP)

(21) Appl. No.: 14/715,901

(22) Filed: May 19, 2015

(30) Foreign Application Priority Data
Jul. 16, 2014 (JP) 2014-146020

(51) Int. Cl. G03G 15/04; F21V 19/00

(52) U.S. Cl. CPC G03G 15/04054; F21V 19/00

(57) ABSTRACT

A light emission element array chip includes light emission light groups each of which includes N light emission elements arranged in a sub-scanning direction. The light emission light groups include a first block of the light emission element groups arranged at intervals of a first predetermined distance in a main-scanning direction. The light emission light groups further include a second block of one or more of the light emission element groups at either end side of the light emission element array chip shifted from a position of each light emission element group included in the first block of the light emission element groups by a second predetermined distance in the sub-scanning direction.

### BACKGROUND OF THE INVENTION

1. Field of the Invention

The present invention relates to a light emission element array chip, a chip mounting substrate, and an image forming apparatus.

2. Description of the Related Art

As image writing devices or exposure devices in image forming apparatuses such as copiers, printers, facsimile machines or so, there are those employing light emission element array chips where a plurality of light emission elements such as light emission diodes (LEDs), organic electroluminescence (OEL) devices, or so, are arranged in line, or fixed scanning type line heads (hereinafter, simply referred to as “line heads”) such as light emission array heads or so. In a printer employing the line head, the line head irradiates an electrified surface of a photoconductor drum to form an electrostatic latent image; a toner image is formed as a result of a toner being put on the electrostatic latent image (developing); and the toner image is transferred to paper and is fixed there.

Recently and continuing, in a copier or a printer, printing is carried out at a higher printing density for the purpose of improving the printing quality. Therefore, an improvement in the printing density is required from approximately 600 dpi to 1200 dpi or more.

In order to achieve the printing density of 1200 dpi, the distance between light emission elements is as small as approximately 21 μm. When such a configuration is implemented by adjacently mounting light emission element array chips on a substrate in line, it is necessary to consider a mounting error of the chips and a distance between a light emission element and a chip edge. According to recent manufacturing technology, the chip mounting error may be on the order of ±6 μm and the distance between a light emission element and a chip edge may be on the order of 3 μm. Therefore, it may be necessary to set the side length of a light emission element to be 3 μm. Note that, actually, by further considering a chip dicing error, it may be necessary to further reduce the size of a light emission element.

Exposure energy given to a photoconductor by a light emission element is in proportion to the size of the light emission element. As a result of the size of a light emission element being reduced as mentioned above, exposure energy given to a photoconductor may become insufficient. Also it may be possible to supplement the energy by increasing the input current to drive the light emission element, the service life of the light emission element may be reduced accordingly, and therefore, but the service life of the apparatus employing the light emission elements may become insufficient. In order to avoid such a situation, it may be necessary to increase the size of the light emission elements as much as possible, whereby, even if the driving current is reduced to ensure the sufficient service life of the light emission elements, the sufficient exposure energy given to the photoconductor can be ensured.

In order to solve such a problem, Japanese Laid-Open Patent Application No. 09-263004 (Patent Reference No. 1) discloses a configuration where LED chips are arranged in such a manner that the adjacent LED chips overlap each other along the light emission element arranging direction. Japanese Laid-Open Patent Application No. 10-244706 (Patent Reference No. 2) discloses a configuration where the width of light emission elements at the end parts of light emission element array chips is reduced in comparison to the other light emission elements.

### SUMMARY OF THE INVENTION

According to one aspect of the present invention, a light emission element array chip has a plurality of light emission element groups arranged thereon. Each of the light emission element groups includes N light emission elements arranged in a sub-scanning direction, where N denotes a natural number. The light emission element groups include a first block of the light emission element groups arranged at intervals of a first predetermined distance in a main-scanning direction; and a second block of one or more of the light emission element groups at either end side of the light emission element array chip shifted from a reference position by a second predetermined distance in the sub-scanning direction, the reference position being a position of each light emission element group included in the first block of the light emission element groups.

Other objects, features, and advantages of the present invention will become more apparent from the following detailed description when read in conjunction with the accompanying drawings.

### BRIEF DESCRIPTION OF THE DRAWINGS

FIG. 1 is a general side view illustrating a configuration of an image forming apparatus 100 according to a first embodiment of the present invention;

FIG. 2 is a plan view of a chip mounting substrate 1 shown in FIG. 1;

FIG. 3A is a magnified view of an area E of FIG. 2;

FIG. 3B is a view corresponding to FIG. 3A illustrating a case where a chip edge is shaped in a manner of being bent at a predetermined angle;

FIG. 3C is a view corresponding to FIG. 3A illustrating a case where the number of light emission element groups included in a second block of one or more of light emission element groups is increased;

FIG. 4 is a general side view illustrating a configuration of an image forming apparatus 100A according to a second embodiment of the present invention;

FIG. 5 is a magnified view of an end part of a light emission element array chip shown in FIG. 4;

FIG. 6 includes, in an upper part, a magnified view of an end part of a light emission array chip 10-m illustrating a first state of adjacently arranging the light emission element array chip 10-m and a light emission element array chip 10-(m+1) of FIG. 2, and, in a lower part, a general view illustrating a printing result of the state of the upper part;

FIG. 7 includes, in an upper part, a magnified view of the end part of the light emission array chip 10A-m illustrating the first state of adjacently arranging the light emission element array chip 10A-m and the light emission element array chip 10A-(m+1) of FIG. 5, and, in a lower part, a general view illustrating a printing result of the state of the upper part;

FIG. 8 includes, in an upper part, a magnified view of the end part of the light emission array chip 10-m illustrating a second state of adjacently arranging the light emission element array chip 10-m and the light emission element array chip 10-(m+1) of FIG. 2, and, in a lower part, a general view illustrating a printing result of the state of the upper part;

FIG. 9 includes, in an upper part, a magnified view of the end part of the light emission array chip 10A-m illustrating the second state of adjacently arranging the light emission element array chip 10A-m and the light emission element array chip 10A-(m+1) of FIG. 5, and, in a lower part, a general view illustrating a printing result of the state of the upper part;

FIG. 10 includes, in an upper part, a magnified view of the end part of the light emission array chip 10-m illustrating a third state of adjacently arranging the light emission element array chip 10-m and the light emission element array chip 10-(m+1) of FIG. 2, and, in a lower part, a general view illustrating a printing result of the state of the upper part; and

FIG. 11 includes, in an upper part, a magnified view of the end part of the light emission array chip 10A-m illustrating the third state of adjacently arranging the light emission element array chip 10A-m and the light emission element array chip 10A-(m+1) of FIG. 5, and, in a lower part, a general view illustrating a printing result of the state of the upper part.

### DETAILED DESCRIPTION OF THE EMBODIMENTS

The embodiments of the present invention relate to light emission element array chips and chip mounting substrates for image forming apparatuses such as copiers, printers, facsimile machines, or so, and the image forming apparatuses.

According to Patent Reference No. 1 mentioned above, a plurality of the light emission element array chips are arranged in a sub-scanning direction, the head width may thus increase, the size of the apparatus including them may increase, and thus, the cost may increase. Also, printing is carried out from light emission points shifted in the sub-scanning direction, and therefore, light emission control may become complicated; thus the cost required for the control may increase. According to Patent Reference No. 2 mentioned above, the light emission elements at the end parts of the light emission element array chip are smaller than the other light emission elements. Therefore, it may be necessary to increase the current amount supplied to the light emission elements at the end parts to cause them to emit light in the same brightness as the other light emission elements. However, in this way, the current density of the light emission elements at the end parts increase accordingly, and therefore, deterioration of the light emission elements at the end parts may be accelerated in comparison to the other light emission elements.

An object of the embodiments of the present invention is to solve the problem by providing a light emission array chip by which it is possible to increase a margin in arranging when mounting the light emission element array chips on a substrate without reducing the size of light emission elements at end parts of the light emission element array chip.

Below, with reference to the drawings, the embodiments of the present invention will be described. Note that, for each embodiment, the same reference signs are used for the same or similar parts/elements/components.

### First Embodiment

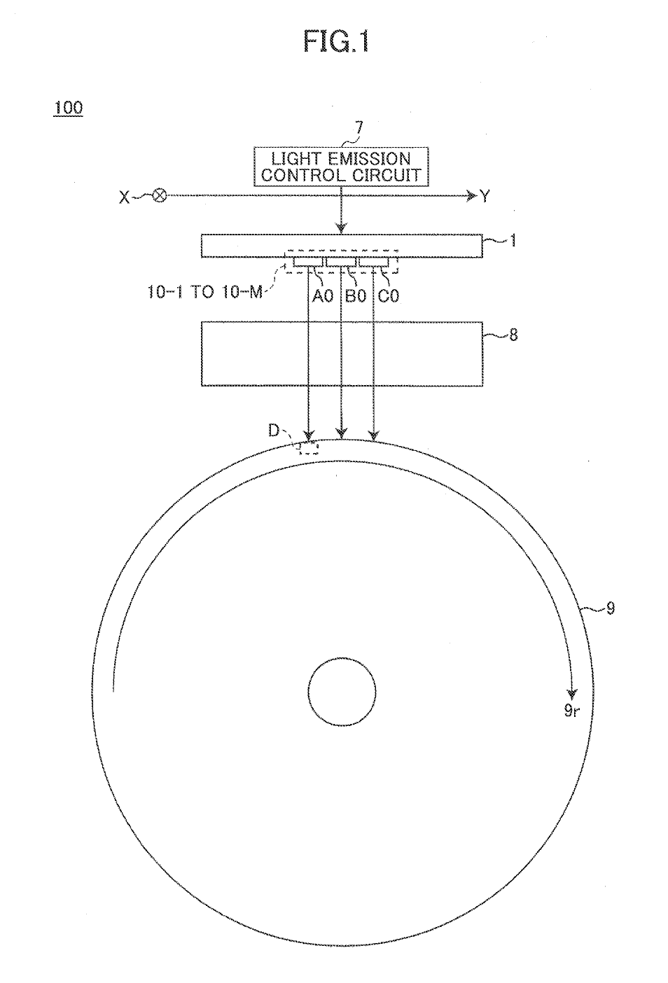

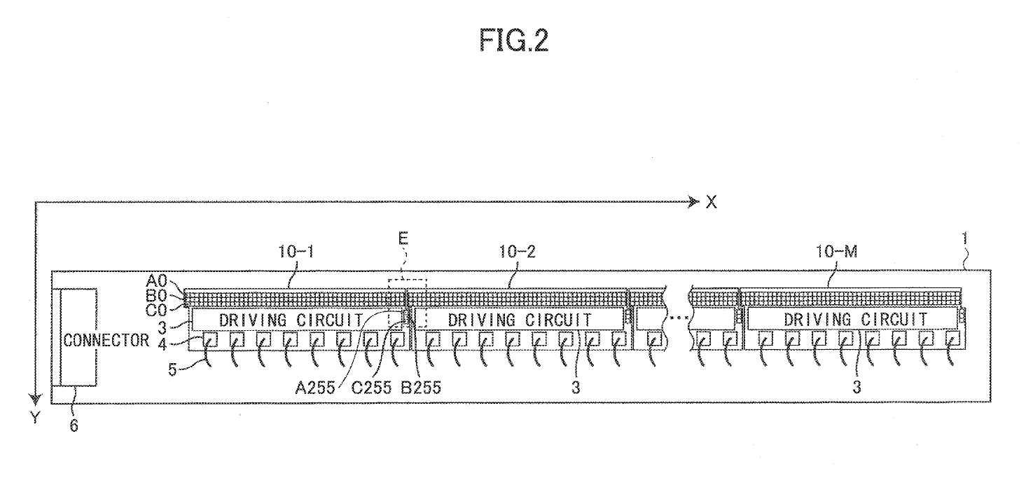

FIG. 1 is a general side view illustrating a configuration of an image forming apparatus 100 according to the first embodiment of the present invention. FIG. 2 is a plan view of a chip mounting substrate 1 shown in FIG. 1. The image forming apparatus 100 of FIG. 1 includes a light emission control circuit 7, a chip mounting substrate 1 on which a plurality of, i.e., M light emission element array chips (hereinafter, which may be simply referred to as “chips”) 10-1, . . . , 10-M are formed to be adjacent to each other in a main-scanning direction X, an optical writing unit 8 including image forming elements that condense light, and a photoconductor drum 9 on which an image (an electrostatic latent image) is formed as a result of light being irradiated through the optical writing unit 8.

As shown in FIG. 2, on each of the light emission element array chips 10-m (m=1, 2, . . . , and M), a plurality of light emission elements A0-C0, . . . , and A255-C255 are arranged in line in the main-scanning direction X. In other words, on each of the light emission element array chips 10-m, 256 light emission element groups in each of which the three light emission elements An-Cn (n=0, 1, . . . , or 255) are arranged in a sub-scanning direction Y at equal distance are arranged in the main-scanning direction X at equal distance in 256 rows. Note that, according to the first embodiment, the light emission elements A0-C0, . . . , and A255-C255 are made using, for example, inorganic LEDs, organic LEDs, organic electroluminescent elements, or so.

The chip mounting substrate 1 of FIG. 2 is such that the light emission element array chips 10-1 to 10-M having wire bonding pads 4 are arranged adjacently to each other in the main-scanning direction X. Each light emission element array chip 10-m includes the light emission elements A0-C0, . . . , and A255-C255, and a driving circuit 3 carrying out control such as to selectively turn on or off the light emission elements A0-C0, . . . , and A255-C255.

In FIG. 2, each of the light emission element array chips 10-1, . . . , and 10-M is connected with the chip mounting substrate 1 electrically via bonding wires 5. Each light emission element array chip 10-1, . . . , or 10-M receives a light emission control signal from the light emission control circuit 7 via a connector 6 of the chip mounting substrate 1. Each light emission element array chip 10-1, . . . , or 10-M carries out gradation representation of each pixel by multiple exposures of the photoconductor drum 9 by selectively turning on or off each of the light emission elements A0-C0, and A255-C255 based on the light emission control signal.

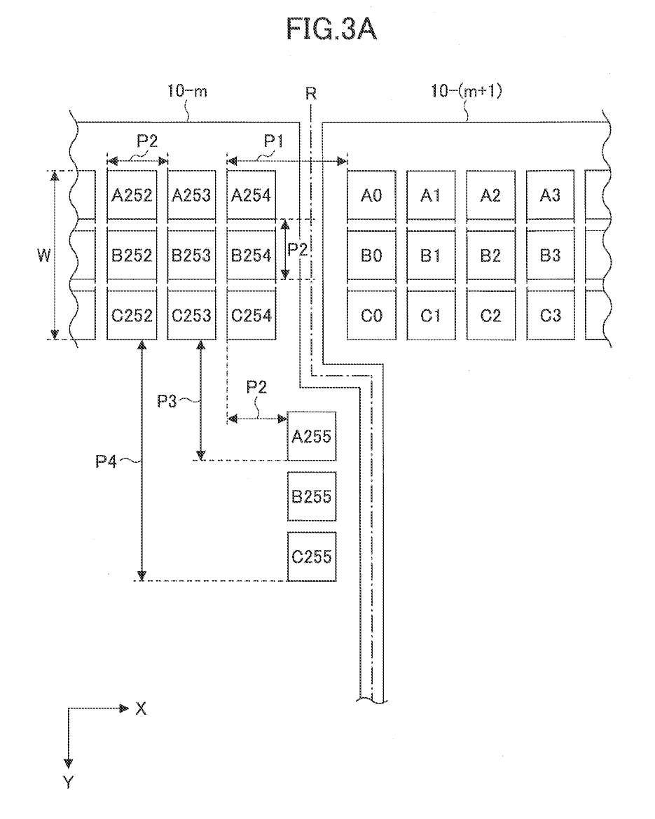

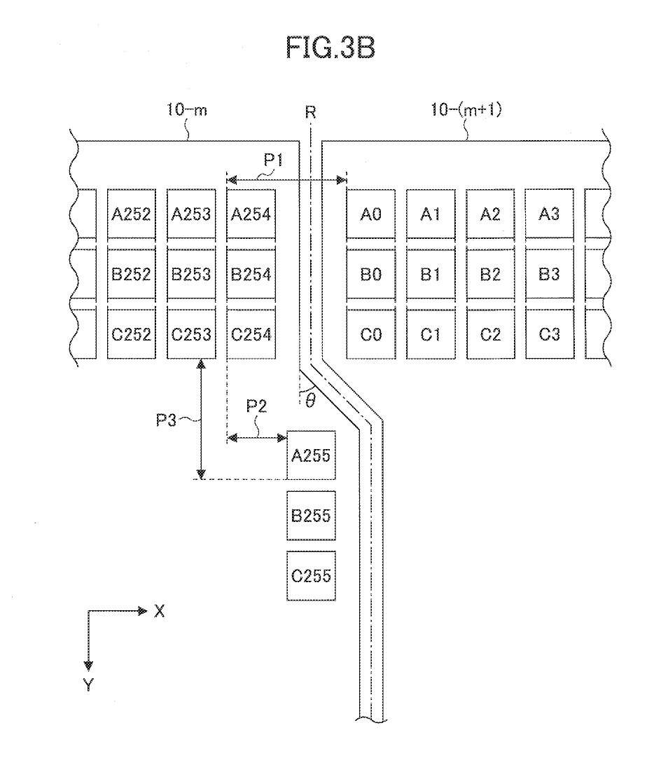

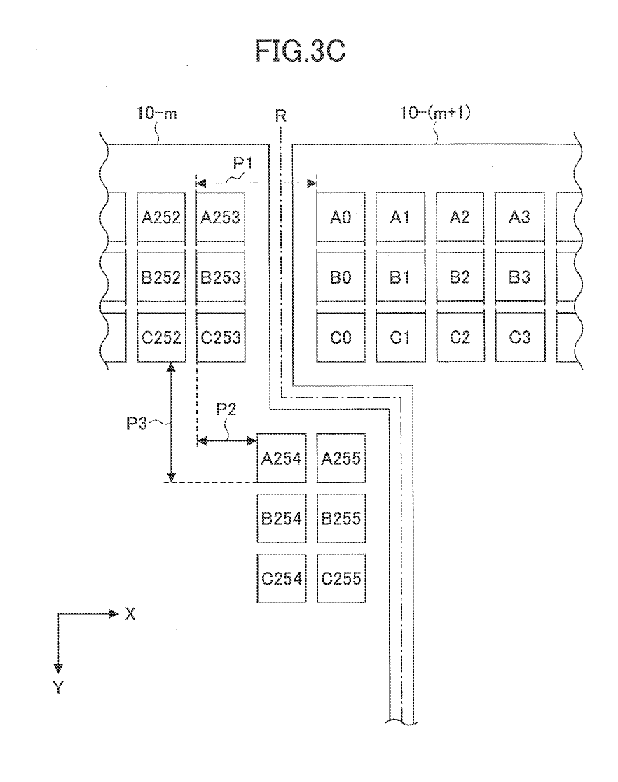

In FIG. 2, as shown, the light emission elements A255-C255 at one end side in the main-scanning direction X of each of the light emission element array chips 10-1 to 10-M are shifted in the sub-scanning direction Y. Along the arrangement of the thus shifted light emission elements A255-C255, dicing is carried out to shape each of the light emission element array chips 10-1 to 10-M in such a manner that a corresponding chip edge is shaped to extend squarely as shown in FIG. 3A or in a manner of bending at a lesser predetermined angle θ as shown in FIG. 3B. The respective light emission element array chips 10-1-10-M thus shaped through dicing are mounted on the chip mounting substrate 1 in line in the main-scanning direction X.

FIG. 3A is a magnified view of an area E of FIG. 2. FIG. 3B is a view corresponding to FIG. 3A illustrating a case where the chip edge is bent at the predetermined angle θ as mentioned above. FIG. 3A is the magnified view of the end part of the light emission element array chip 10-m when the light emission element array chip 10-m and the light emission element array chip 10-(m+1) are adjacently arranged. In FIG. 3A, each of the light emission elements An-Cn (n=0 to 255) has a shape of a square having the size of 18 μm by 18 μm. The respective light emission elements An-Cn (n=0, 1, . . . , and 255) are arranged to form 256 rows in the main-scanning direction X and three lines in the sub-scanning direction Y, at a distance of a pitch P2 (P2=21 μm) (1200 dpi), as shown in FIG. 3A. Note that “a distance of light emission elements” means a distance between light emission elements measured at their corresponding points.

According to the first embodiment, the light emission elements A255-C255 at the right end side of the light emission element array chip 10-m are shifted in the sub-scanning direction Y by the distance of (the light emission element pitch P2) x (the number of the light emission elements arranged in line in the sub-scanning direction+1). In the example of FIG. 3A, the number of the light emission elements arranged in the sub-scanning direction is 3, and therefore, the light emission elements A255-C255 are shifted by the distance P4 (P4=P2×(3+1)=21×4=84 μm). Thus, the light emission element array on chip 10-m has a first block of the light emission element groups where a plurality of light emission element groups including the light emission elements A0-C0, . . . , and A254-C254, respectively, are arranged at intervals of a first predetermined distance (P2) in the main-scanning direction X.

Further, the light emission element array chip 10-m has a second block of one or more of the light emission element groups (i.e., one light emission element group A255-C255 in the example of FIG. 3A) where a light emission element group including the light emission elements A255-C255 at either end side in the main-scanning direction X of the light emission element array chip 10-m is shifted from a reference position by a second predetermined distance in the sub-scanning direction Y. Note that the “reference position” means the position of each light emission element group included in the first block of the light emission element groups, and the “second predetermined distance” (P4 in the example of FIG. 3A) is set to be equal to or greater than the width (“w” in the example of FIG. 3A) of each light emission element groups in the sub-scanning direction Y.

In FIG. 3A, the distance P1 between the left edge of the light emission element group including the light emission elements A254-C254 of the light emission element array chip 10-m and the left edge of the light emission element group including the light emission elements A0-C0 of the light emission element array chip 10-(m+1) is 42 μm. The distance P3 between the bottom edge of the first block of the light emission element groups (A0-C0 to A254-C254) and the bottom edge of the light emission element A255 of the second block of one or more of the light emission element groups (A255-C255) is 42 μm. By this shift, it is possible to increase the margin in arranging the dicing area of the light emission element array chip 10-m in comparison to the related art. At the same time, it is also possible to increase the margin in arranging a die bonding reference position R between adjacent chips for mounting the chips.

Now, operations of the image forming apparatus 100 according to the first embodiment configured as described above will be described.

By selectively turning on or off the three light emission elements An-Cn (n=0, 1, . . . , or 255) and carrying out multiple exposures of the photoconductor drum 9 based on the light emission control signal from the light emission control circuit 7 of FIG. 1, each pixel is expressed with three gradations. In other words, the three light emission elements An-Cn (n=0, 1, . . . , or 255) form a pixel through multiple exposures of the same position in the main-scanning direction X.

In FIG. 1, by carrying out exposure with the light emission element An at the drawing area D and rotating the photoconductor drum 9 clockwise 9r, the drawing area D is relatively moved in the sub-scanning direction Y with respect to the light emission element array chip 10-m. Next, by carrying out exposure with the light emission element Bn at a drawing area D and rotating the photoconductor drum 9 clockwise 9r, the drawing area D is relatively moved in the sub-scanning direction Y with respect to the light emission element array chip 10-m. Similarly, by carrying out exposure with the light emission element Cn at the drawing area D and rotating the photoconductor drum 9 clockwise 9r, the drawing area D is relatively moved in the sub-scanning direction Y with respect to the light emission element array chip 10-m. Thus, it is possible to carry out the maximum three exposures at the drawing area D.

According to the image forming apparatus 100 of the first embodiment described above, the light emission element group at either end side in the main-scanning direction X of each light emission element array chip 10-m is shifted in the sub-scanning direction Y. Then, dicing is carried out to shape the light emission array chip 10-m in such a manner that the corresponding edge of the light emission array chip 10-m is shaped to extend squarely along the arrangement of the respective light emission elements of the thus shifted light emission element group. Then, the thus shaped the light emission element array chips 10-m are mounted on the chip mounting substrate 1 in such a manner that they are arranged in the main-scanning direction X in line there. Therefore, it is possible to increase the margin in arranging when mounting the light emission element array chips 10-m on the chip mounting substrate 1 in comparison to the related art without reducing the size of the light emission elements at the ends of each light emission element array chip 10-m. It is also possible to provide the image forming apparatus by which it is possible to avoid degradation in the image quality even when carrying out high density printing.

Note that in the above-described first embodiment, only one row of the light emission elements A255-C255 at the right end side in the main-scanning direction X of each light emission element array chip 10-m is shifted in the sub-scanning direction Y. However, the present invention is not limited thereto. For example, as shown in FIG. 3C, it is also possible to shift two rows of the light emission elements A254-C254 and A255-C255 at the right end side in the main-scanning direction X of each light emission element array chip 10-m in the sub-scanning direction Y. It is also possible to shift three or more rows of the light emission elements at the right end side in the main-scanning direction X of each light emission element array chip 10-m in the sub-scanning direction Y. Thereby, in comparison to the first embodiment, it is possible to further increase the margin in arranging when mounting the light emission element array chips 10-m on the chip mounting substrate 1.

### Second Embodiment

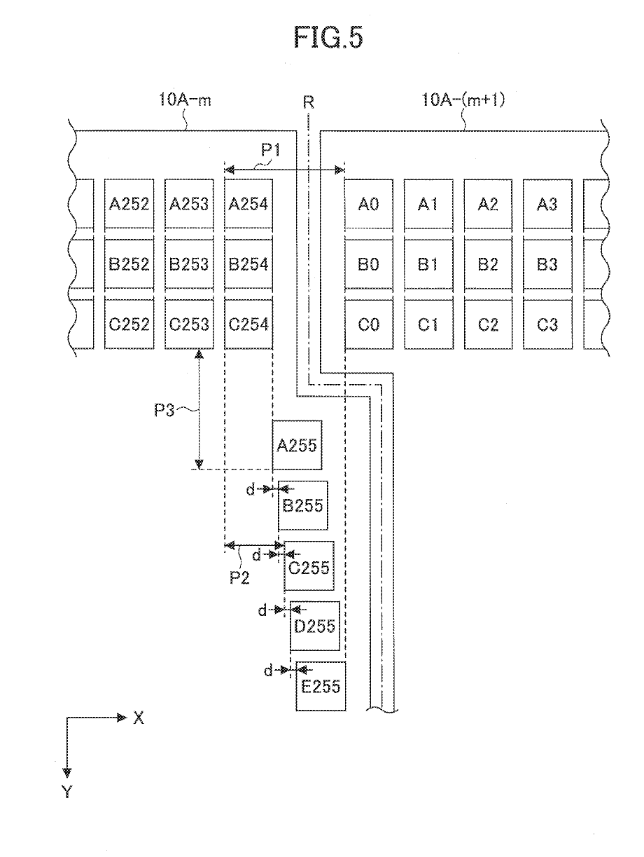

In the image forming apparatus 100 according to the first embodiment described above, an error may occur when the respective light emission element array chips 10-m are mounted on the chip mounting substrate 1. Thereby, a stripe-shaped gradation difference in the longitudinal direction (a “longitudinal stripe”) may occur in a printing result. In contrast thereto, according to the second embodiment, light emission elements (D255 and E255 in the example of FIG. 5 which will be described later) are additionally provided for reducing such an error at a time of the mounting to reduce the “longitudinal stripe” appearing in the printing result.

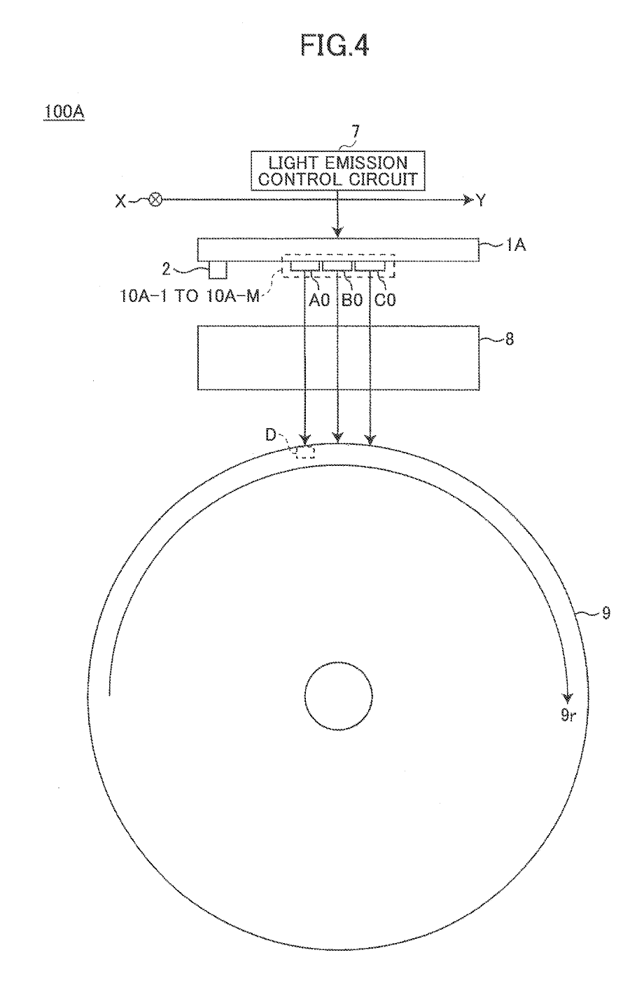

FIG. 4 is a general side view illustrating a configuration of an image forming apparatus 100A according to the second embodiment of the present invention. The image forming apparatus 100A of FIG. 4 is different from the image forming apparatus 100 of FIG. 1 in that, instead of the chip mounting substrate 1, a chip mounting substrate 1A is provided. The chip mounting substrate 1A is different from the chip mounting substrate 1 in that, instead of the light emission element array chips 10-m (m=0, 1, . . . , and M), light emission element array chips 10A-m (m=0, 1, . . . , and M) are provided. Also, the chip mounting substrate 1A includes a register 2 as a storage device that stores correction data for selecting light emission elements for reducing a variation in the positions of light emission elements which may occur at a time of mounting the light emission element array chips 10A-m on the chip mounting substrate 1A (i.e., an error which may occur at a time of mounting the chips 10A-m). In other words, based on the correction data, three light emission elements to be activated are selected from each light emission element group included in the second block of one or more of the light emission element groups (i.e., one light emission element group A255-E255 in the example of FIG. 5). The register 2 can be made of a storage memory such as a nonvolatile memory such as a mask ROM, an FRAM (registered trademark), an EPROM, an EEPROM, a FeROM, a flash memory, or so. Note that the correction data is previously set before the shipment of the chip mounting substrate 1A. The light emission elements A0-C0, . . . , and A255-E255 are made by, for example, inorganic LEDs, organic LEDs, organic electroluminescent elements, or so.

FIG. 5 is a magnified view of an end part of the light emission element array chip 10A-m. FIG. 5 is the magnified view of the end part of the light emission element 10A-m when the light emission element array chip 10A-m and the light emission element array chip 10A-(m+1) are adjacently arranged. The light emission element array chip 10A-m of FIG. 5 is different from the light emission element array chip 10-m of FIG. 3A in that, instead of the light emission elements A255-C255, the light emission elements A255-E255 are provided. The light emission elements A255-E255 constitute a second block of one or more of the light emission element groups, and the respective light emission elements A255-E255 are shifted an equal distance “d” from each other in the main-scanning direction X as shown in FIG. 5.

Operations of the image forming apparatus 100A according to the second embodiment described above are similar to those of the image forming apparatus 100 according to the first embodiment. Below, differences from the operations of the image forming apparatus 100 according to the first embodiment will be described.

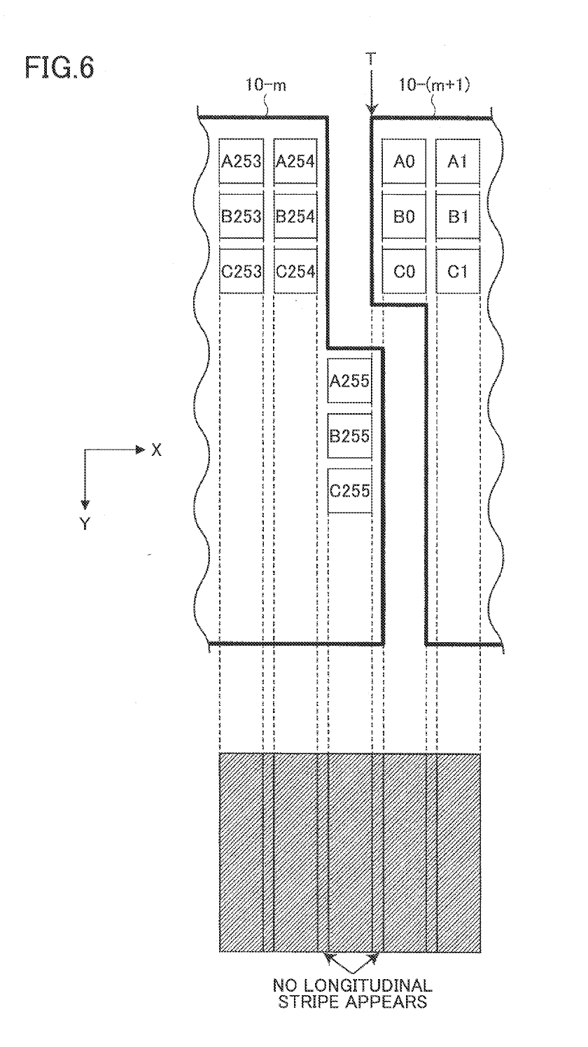

FIG. 6 includes, in an upper part, a magnified view of an end part of the light emission array chip 10-m illustrating a first state of adjacently arranging the light emission element array chip 10-m and the light emission element array chip 10-(m+1) in the configuration of FIG. 2, and, in a lower part, a general view illustrating a printing result of the state of the upper part. The upper part of FIG. 6 shows a case where the adjacent chip 10-(m+1) is mounted approximately at a target position T, and, in other words, the distance between the adjacent chips is such that each of the distances between the adjacent chips in the main-scanning direction X including the distance between the light emission elements A255-C255 at the right end of the light emission array chip 10-m and the adjacent light emission elements A0-C0 of the light emission array chip 10-(m+1) in the main-scanning direction X is approximately the same as the pitch P2 (see 3A). In this case, because the respective distances between the adjacent light emission elements in the main-scanning direction X distance are approximately equal to each other, no “longitudinal stripe” appears in the printing result as shown in the lower part of FIG. 6. Note that because each light emission element emits light in a range wider than the size the light emission element itself, printing is made in a range including the outside of the light emission element.

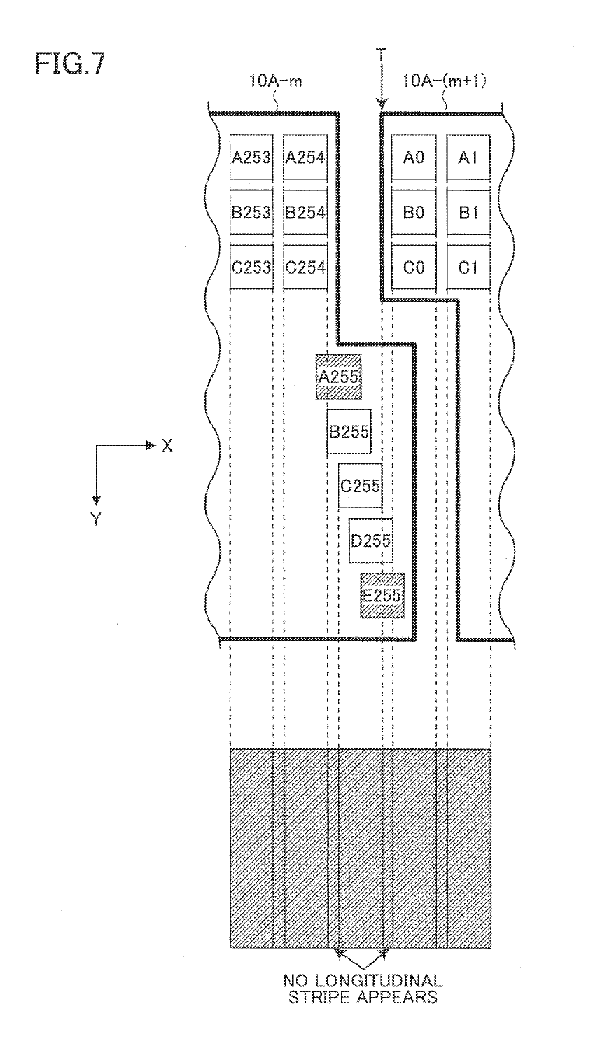

FIG. 7 includes, in an upper part, a magnified view of the end part of the light emission array chip 10A-m illustrating the first state of adjacently arranging the light emission element array chip 10A-m and the light emission element array chip 10A-(m+1) of FIG. 5, and, in a lower part, a general view illustrating a printing result of the state of the upper part. The upper part of FIG. 7 shows a case where the adjacent chip 10A-(m+1) is mounted approximately at the target position T, and, in other words, the distance between the adjacent chips is such that each of the distances between the adjacent chips in the main-scanning direction X including the distance between the light emission elements B255-D255 and the adjacent light emission elements A0-C0 in the main-scanning direction X is approximately the same as the pitch P2 (see 3A). In this case, a setting is made based on the correction data such that the light emission element B255, C255 and D255 are used and the light emission elements A255 and E255 are not used (hatched in the figure), as shown in FIG. 7, in the upper part. By this setting, no overlap is present between the light emission elements B255-D255 at the right end of the light emission array chip 10A-m and the adjacent light emission elements A0-C0 of the light emission array chip 10A-(m+1) in the main-scanning direction X. As a result, no “longitudinal stripe” appears even when the light emission elements A255-E255 are arranged in such a manner that they are shifted, little by little (i.e., “d”, as described above with reference FIG. 5), respectively, in the main-scanning direction X as shown in FIG. 7, in the upper part.

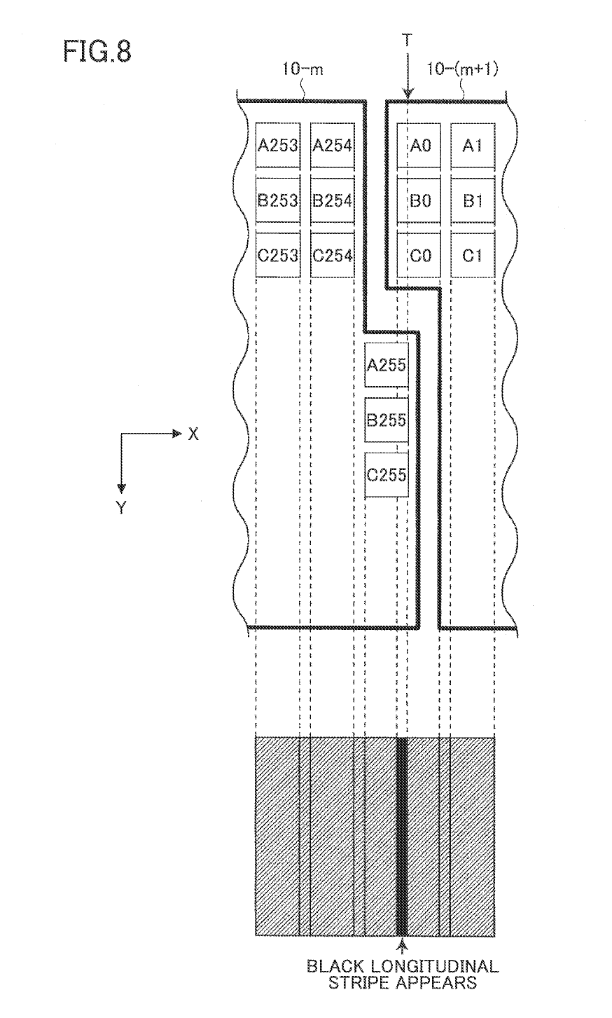

FIG. 8 includes, in an upper part, a magnified view of the end part of the light emission array chip 10-m illustrating a second state of adjacently arranging the light emission element array chip 10-m and the light emission element array chip 10-(m+1) in the configuration of FIG. 2, and, in a lower part, a general view illustrating a printing result of the state of the upper part. The upper part of FIG. 8 shows a case where the adjacent chip 10-(m+1) is mounted inside the target position T, and, in other words, the distance between the adjacent chips 10-m and 10-(m+1) is shorter such that the distance between the adjacent light emission elements A255-C255 and A0-C0 in the chips 10-m and 10-(m+1) in the main-scanning direction X is shorter than the pitch P2. In this case, as shown in FIG. 8, in the upper part, the light emission elements A255-C255 overlap with the light emission elements A0-C0 between the adjacent chips 10-m and 10-(m+1) in the main-scanning direction X. In other words, overlaps are present among the six light emission elements A255-C255 and A0-C0 at the right end parts of the light emission elements A255-C255 and the left end parts of the light emission element A0-C0 in the main-scanning direction X. Assuming that the printing density increases as the exposure amount increases, these overlaps result in an increase in the exposure amount, and the printing result thereby includes a black “longitudinal stripe” at the corresponding position in the main-scanning direction X, as shown in FIG. 8, the lower part.

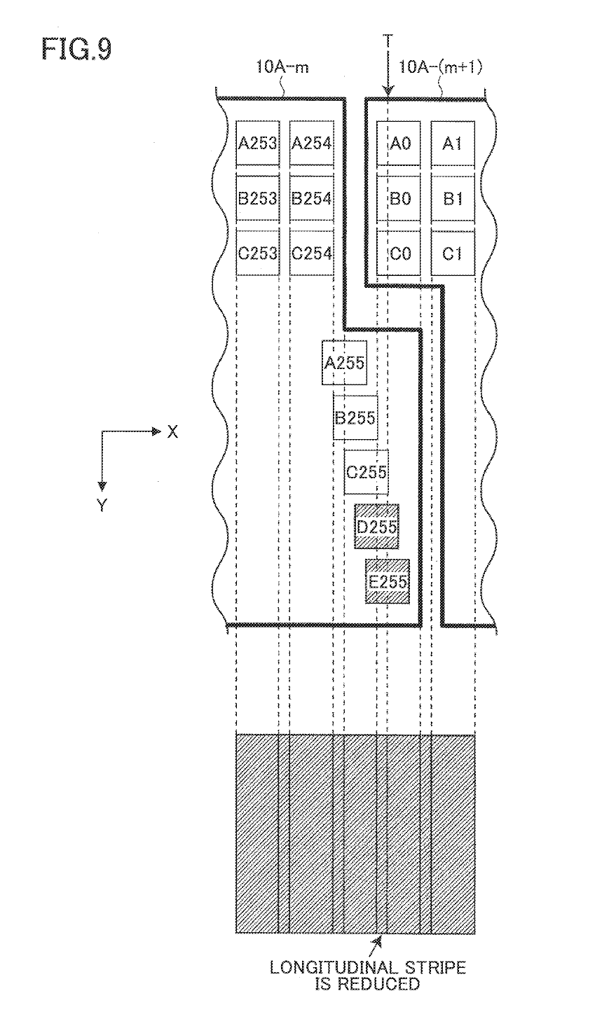

FIG. 9 includes, in an upper part, a magnified view of the end part of the light emission array chip 10A-m illustrating the second state of adjacently arranging the light emission element array chip 10A-m and the light emission element array chip 10A-(m+1) of FIG. 5, and, in a lower part, a general view illustrating a printing result of the state of the upper part. The upper part of FIG. 9 shows a case where the adjacent chip 10A-(m+1) is mounted inside the target position T, and, in other words, the distance between the adjacent chips 10A-m and 10A-(m+1) is shorter such that the distance between the adjacent light emission elements A255-E255 and A0-C0 in the chips 10A-m and 10A-(m+1) in the main-scanning direction X is shorter than the pitch P2. In this case, a setting is made based on the correction data such that the light emission elements A255, B255 and C255 are used and the light emission elements D255 and E255 (hatched in the figure) are not used, as shown in FIG. 9, in the upper part. By this setting, some overlap is present between the light emission elements A255-C255 at the right end of the chip 10A-m and the adjacent light emission elements A0-C0 of the chip 10A-(m+1). However, because it is possible to reduce the overlap parts in comparison to the case of FIG. 8, it is possible to reduce the black “longitudinal stripe”. In fact, in the case of FIG. 8, as described above, the overlaps are present among the six light emission elements A255-C255 and A0-C0 at the right end parts of the light emission elements A255-C255 and the left end parts of the light emission element A0-C0 in the main-scanning direction X. In contrast thereto, in the case of FIG. 9, the overlaps are present only among the four light emission element C255 and A0-C0 at the right end part of the light emission element C255 and the left end parts of the light emission element A0-C0 in the main-scanning direction X. Thus the overlap parts are reduced from the six parts to the four parts.

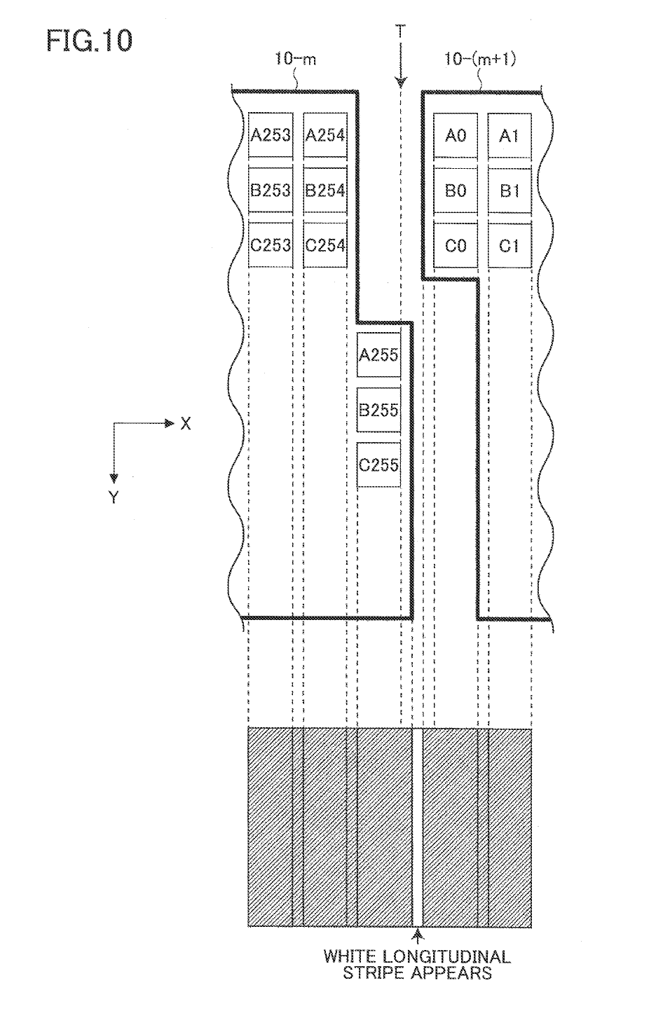

FIG. 10 includes, in an upper part, a magnified view of the end part of the light emission array chip 10-m illustrating a third state of adjacently arranging the light emission element array chip 10-m and the light emission element array chip 10-(m+1) in the configuration of FIG. 2, and, in a lower part, a general view illustrating a printing result of the state of the upper part. The upper part of FIG. 10 shows a case where the adjacent chip 10-(m+1) is mounted outside the target position T, and, in other words, the distance between the adjacent chips 10-m and 10-(m+1) is greater such that the distance between the adjacent light emission elements A255-C255 and A0-C0 in the chips 10-m and 10-(m+1) in the main-scanning direction X is greater than the pitch P2. In this case, the distance between the light emission elements A255-C255 and the light emission elements A0-C0 between the adjacent chips 10-m and 10-(m+1) in the main-scanning direction X is greater. As a result, a part where no exposure is carried out or weak exposure is carried out is present therebetween. Therefore, the printing result includes a white “longitudinal stripe” at the corresponding position in the main-scanning direction, as shown in FIG. 10, the lower part.

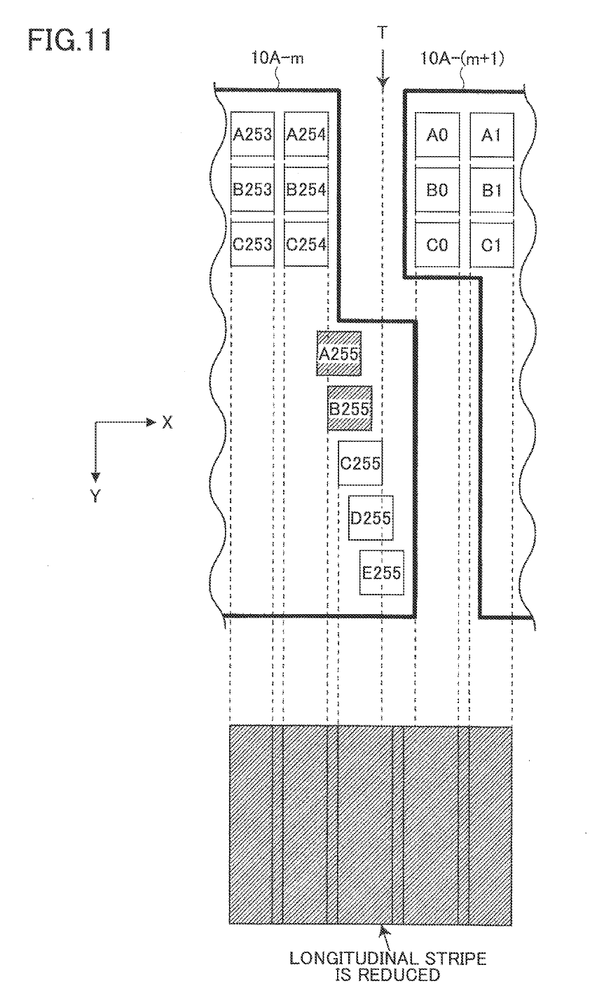

FIG. 11 includes, in an upper part, a magnified view the end part of the light emission array chip 10A-m illustrating the third state of adjacently arranging the light emission element array chip 10A-m and the light emission element array chip 10A-(m+1) of FIG. 5, and, in a lower part, a general view illustrating a printing result of the state of the upper part. The upper part of FIG. 9 shows a case where the adjacent chip 10A-(m+1) is mounted outside the target position T, and, in other words, the distance between the adjacent chips 10A-m and 10A-(m+1) is greater such that the distance between the adjacent light emission elements A255-E255 and A0-C0 in the chips 10A-m and 10A-(m+1) in the main-scanning direction X is greater than the pitch P2. In this case, a setting is made based on the correction data such that the light emission element C255, D255 and E255 are used and the light emission elements A255 and B255 (hatched in the figure) are not used. By this setting, the distance between the light emission elements C255-E255 at the right end of the chip 10A-m and the adjacent light emission elements A0-C0 of the chip 10A-(m+) is reduced. Therefore, the part where weak exposure is carried out is reduced in comparison to the case of FIG. 10, and thus, it is possible to reduce the white “longitudinal stripe” appearing in the printing result.

According to the image forming apparatus 100A of the second embodiment described above, it is possible to acquire the same advantageous effects as those of the image forming apparatus 100 according to the first embodiment. Further, in comparison to the image forming apparatus 100 according to the first embodiment, the light emission elements are added for reducing an error occurring when mounting the chips on the substrate. As a result, it is possible to reduce a “longitudinal stripe” appearing in a printing result due to the error occurring when mounting the chips on the substrate, as mentioned above.

Note that in the second embodiment, the number of the light emission elements included in each of light emission element groups of the second block of one or more of the light emission element groups is set to be greater, by two (i.e., the light emission elements D255 and E255), than the number of the light emission elements (i.e., three) included in each light emission element group (the light emission elements A0-C0, . . . , or A254-C254) included in the first block of the light emission element groups. However, the present invention is not limited thereto, and, for example, it is possible to set the number of the light emission elements included in each light emission element group included in the second block of one or more of the light emission element groups to be greater, by three or more, than the number of the light emission elements included in each light emission element group include in the first block of the light emission element groups. Thereby, it is possible to carry out finer control according to the distance between the adjacent chips.

Note that in the second embodiment, the number of the light emission elements included in each light emission element group included in the second block of one or more of the light emission element groups is set to be greater, by two, than the number of the light emission elements included in each light emission element group included in the first block of the light emission element groups. However, the present invention is not limited thereto, and, for example, it is also possible to increase or decrease the quantity of light of the light emission element A255 or C255 in the second block of one or more of the light emission element groups to compensate an error which may occur when the chips are mounted on the chip mounting substrate to reduce a “longitudinal stripe” which may be present in a printing result.

Thus, the light emission element array chips, the chip mounting substrates, and the image forming apparatuses have been described in the embodiments. However, the present invention is not limited to such a specific embodiment, and variations and modifications may be made without departing from the scope of the present invention.

### First Variant

In the above-described first and second embodiments, the cases have been described where each light emission element array chip is such that, generally, the light emission element groups each having the three light emission elements arranged in the sub-scanning direction Y are arranged in the main-scanning direction X at equal distances to form the plurality of rows. However, the present invention is not limited thereto. For example, it is also possible to apply the present invention to each light emission element array chip where a plurality of light emission element groups each of which has N (i.e., a natural number) light emission elements arranged in the sub-scanning direction are arranged.

According to a first variant, a plurality of light emission element groups each of which has N (i.e., a natural number) light emission elements arranged in the sub-scanning direction can be arranged. There, each light emission element array chip includes a first block of the light emission element groups arranged in the main-scanning direction at intervals of a first predetermined distance. The light emission element array chip further has a second block of one or more of the light emission element groups at either end side in the main-scanning direction X of the light emission element array chip shifted in the sub-scanning direction by a second predetermined distance from a reference position. The “reference position” is a position of each light emission element group included in the first block of the light emission element groups. The second predetermined distance can be set to be greater than the width of each light emission element group included in the first block of the light emission element groups in the sub-scanning direction. The number of the light emission elements included in each light emission element group included in the second block of one or more of the light emission element groups can be N+1 or more, and the light emission elements of each light emission element group included in the second block of one or more of the light emission element groups can be shifted an equal distance from each other in the main-scanning direction, as the example shown in FIG. 5. Note that in the example of FIG. 5, the N of the light emission elements (A0-C1, A1-C1, . . . , or A254-C254) of each light emission element group included in the first block of the light emission element groups is three. The number of the light emission elements (A255-E255) of each light emission element group included in the second block of one or more of the light emission element groups (i.e., the one light emission element group in the example of FIG. 5) is five.

A chip mounting substrate according to the first variant has the respective light emission element array chips arranged adjacent to each other in the main-scanning direction, and can have a storage part that stores data (such as the above-described “correction data”, for example) for selecting N light emission elements to be activated from among the light emission elements of each light emission element group included in the second block on of one or more of the light emission element groups (i.e., in the example of FIG. 5, as mentioned above, three light emission elements are selected from the five light emission elements A255-E255). Further, each of the light emission element array chips to be mounted on the chip mounting substrate has the respective light emission element array chips arranged adjacent to each other in the main-scanning direction, and can be shaped through dicing in such a manner that the corresponding edge of the light emission element array chip is shaped to extend along the arrangement of the light emission elements of the light emission element group included in the second block of one or more of the light emission element groups at the end side in the main-scanning direction X of the light emission element array chip. Furthermore, each light emission element array chip can be shaped through dicing in such a manner that the corresponding edge of the light emission element array chip is shaped to extend squarely or in a manner of being bent at a predetermined angle along the arrangement of the light emission elements of the light emission element group included in the second block of one or more of the light emission element groups at the end side in the main-scanning direction X of the light emission element array chip. Further, an image forming apparatus according to the first variant includes the above-mentioned chip mounting substrate (as the image forming apparatus as shown in FIG. 4, for example).

### Second Variant

In the above-described first and second embodiments and the first variant, inorganic LEDs can be used as the light emission elements. However, the present invention is not limited thereto. For example, it is also possible to use organic electroluminescent elements instead of inorganic LEDs as the light emission elements.

Note that each of the above-described image forming apparatuses 100 and 100A can include an image forming part that develops an electrostatic latent image formed on the photoconductor drum 9 with toner; a paper conveyance part that conveys a sheet of paper to a position where the toner image thus formed by the image forming part is transferred to the sheet of paper; and a transfer part that transfers the toner image to the sheet of paper from the photoconductor drum 9. The image forming apparatuses can be, for example, copiers, printers, facsimile machines, or so.

According to the embodiments and the variants described above, it is possible to provide a light emission array chip by which it is possible to increase a margin in arranging when mounting the light emission element array chips on a substrate without reducing the size of light emission elements at end parts of the light emission element array chip in comparison to the related art.

The present application is based on and claims the benefit of priority of Japanese Priority Application No. 2014-146020, filed on Jul. 16, 2014, the entire contents of which are hereby incorporated herein by reference.

What is claimed is:

1. A light emission element array chip comprising:
a plurality of light emission element groups, each of the light emission element groups including N light emission elements arranged in a sub-scanning direction, where N denotes a natural number, wherein
the light emission element groups include
a first block of the light emission element groups arranged at intervals of a first predetermined distance in a main-scanning direction; and
a second block of one or more of the light emission element groups at either end side of the light emission element array chip shifted from a reference position by a second predetermined distance in the sub-scanning direction, the reference position being a position of each light emission element group included in the first block of the light emission element groups.

2. The light emission element array chip as claimed in claim 1, wherein
the second predetermined distance is set to be greater than a width of each light emission element group included in the first block of the light emission element groups in the sub-scanning direction.

3. The light emission element array chip as claimed in claim 1, wherein
the number of the light emission elements of each light emission element group included in the second block of one or more of the light element groups is greater than or equal to N+1.

4. The light emission element array chip as claimed in claim 3, wherein
the light emission elements of each light emission element group included in the second block of one or more of the light element groups are shifted an equal distance from each other in the main-scanning direction.

5. A chip mounting substrate, comprising:
a plurality of the light emission element array chips claimed in claim 4 arranged to be adjacent to each other in the main-scanning direction; and
a storage part that stores data for selecting the N light emission elements to be activated from among those of each light emission element group included in the second block of one or more of the light emission element groups.

6. A chip mounting substrate comprising:
a plurality of the light emission element array chips claimed in claim 1 arranged to be adjacent to each other in the main-scanning direction, wherein
each of the light emission element array chips is shaped through dicing such that a corresponding chip edge is shaped to extend along an arrangement of the light emission elements of one light emission element group included in the second block of one or more of the light emission element groups at an end side of the light emission element array chip.

7. The chip mounting substrate as claimed in claim 6, wherein
each of the light emission element array chips is shaped through dicing such that a corresponding chip edge is shaped to extend squarely or in a manner of being bent at a predetermined angle along the arrangement of the light emission elements of one light emission element group included in the second block of one or more of the light emission element groups at an end side of the light emission element array chip.

8. An image forming apparatus comprising:
the chip mounting substrate claimed in claim 5.

9. An image forming apparatus comprising:
the chip mounting substrate claimed in claim 6.
